(19) United States
(12) Patent Application Publication
(10) Pub. No.: US 2006/0071650 A1
(43) Pub. Date: Apr. 6, 2006

(54) CPU power delivery system

(76) Inventors: Siva G. Narendra, Portland, OR (US); Howard A. Wilson, Beaverton, OR (US); Donald S. Gardner, Mountain View, CA (US); Peter Hazucha, Beaverton, OR (US); Gerhard Schrom, Hillsboro, OR (US); Tanay Karnik, Portland, OR (US); Nitin Borkar, Portland, OR (US); Vivek De, Beaverton, OR (US); Shekhar Y. Borkar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,464

(22) Filed: Sep. 30, 2004

(51) Int. Cl. G05F 1/40

(52) U.S. Cl. 323/285; 323/286

(57) ABSTRACT

A central processing unit (CPU) is disclosed. The CPU includes a CPU die; and a voltage regulator/converter die bonded to the CPU die in a three dimensional packaging layout.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to delivering power to a central processing unit (CPU).

### BACKGROUND

Technology scaling involves the scaling down of the geometry of integrated circuit devices and interconnect lines. Scaling device sizes and lowering supply voltages achieve technology scaling. The overall power consumption of high performance CPUs increases with scaling due to additional functionality. However, lower voltage and higher power leads to very high currents delivered to the high performance CPUs. Holding the low supply rail at its potential at very high current transients has become increasingly challenging for voltage regulator modules (VRMs) externally located at a motherboard.

The discontinuities and impedances in the VRM to die power delivery path give rise to amplitude/phase degradation and response time delay. Thus, the best-case VRM response is typically in KHz to few MHz range. Current power delivery trends include bringing the VRM as close to the die as possible. However, on-die VRM incurs space, power and extra processing cost.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of a CPU;

FIG. 3 illustrates one embodiment of a voltage regulator die; and

FIG. 4 illustrates another embodiment of a voltage regulator die;

### DETAILED DESCRIPTION

According to one embodiment, a power delivery system for a CPU is described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

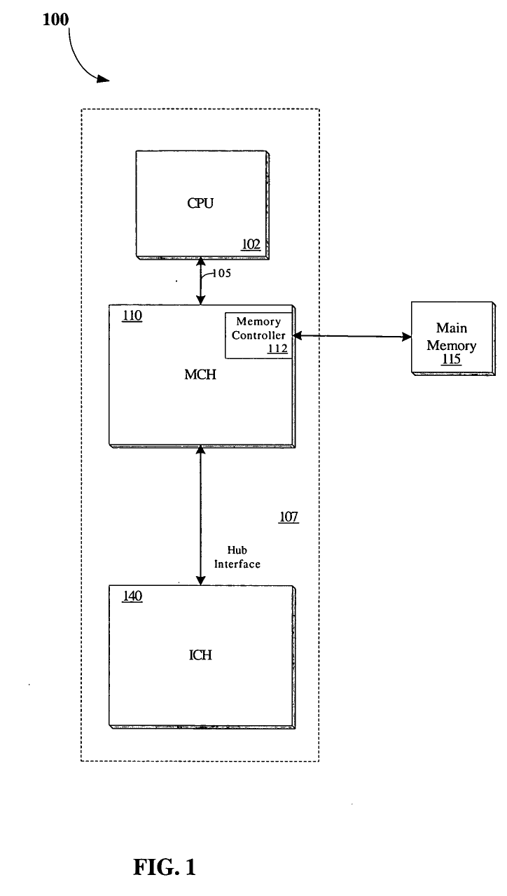

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

Chipset 107 also includes an input/output control hub (ICH) 140 coupled to MCH 110 to via a hub interface. ICH 140 provides an interface to input/output (I/O) devices within computer system 100. For instance, ICH 140 may be coupled to a Peripheral Component Interconnect bus adhering to a Specification Revision 2.1 bus developed by the PCI Special Interest Group of Portland, Oreg.

As discussed above, a motherboard voltage regulator module typically supplies a single Vcc to a CPU, resulting in discontinuities and impedances in the VRM to die power delivery path that give rise to amplitude/phase degradation and response time delay. One method to negate such effects is to move the VRM onto the CPU die. However, on-die VRM incurs space, power and extra processing cost

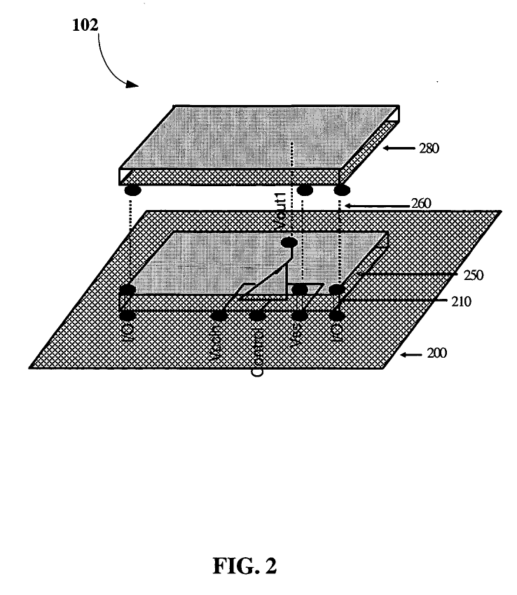

According to one embodiment, a voltage regulator/converter die is bonded to CPU die 200. FIG. 2 illustrates one embodiment of CPU 102. CPU 102 includes a voltage regulator/converter die 250 sandwiched between a CPU die 280 and a package substrate 200. According to one embodiment, voltage regulator/converter die 250 is pad matched to CPU die 280 and package substrate 200 so that die 250 can be an option sandwiched die. Thus, package 200 and CPU 280 design does not need any changes.

In one embodiment, voltage regulator/converter die 300 is in a three dimensional (3D) packaging configuration with die 200. FIG. 2 also shows the I/O connections between die 250 and 280, as well as the die/die bonding. According to one embodiment, die 250 is flipped and bonded (metal-side to metal-side) to supply appropriate cores, thus bringing the voltage regulator/converter as close to the CPU die 200 as possible. In a further embodiment, a heat spreader and heat sink (not shown) may be coupled to CPU die 280.

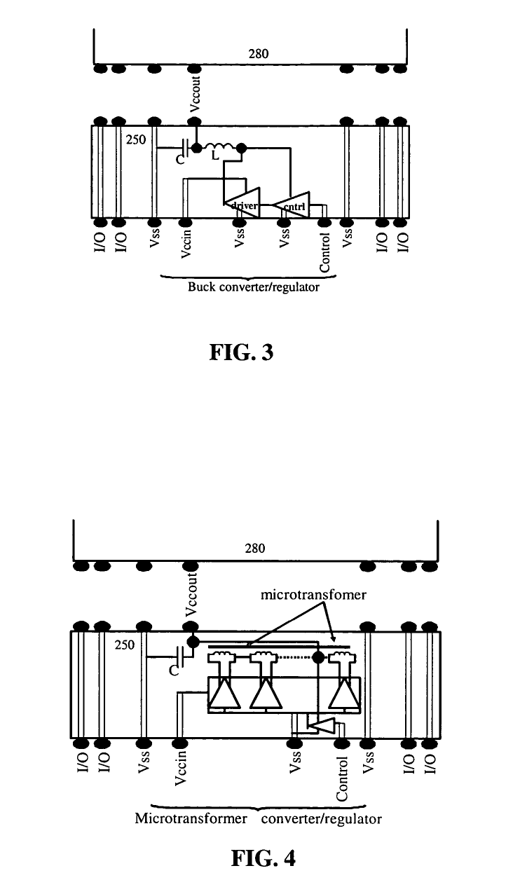

Various types of regulators can be integrated as die 250. FIG. 3 illustrates one embodiment of voltage regulator/converter circuitry mounted on voltage regulator/converter die 250. In such an embodiment, the voltage regulator/converter is implemented with a switching buck DC/DC converter/regulator. In addition, die 250 includes one or more current drivers, a control unit, a switching inductor (L) and an output filter capacitor (C).

In one embodiment, inductor L, capacitor C and the driver are on die 250. In another embodiment, the inductor L is on the package. The control unit adjusts the timing, driving strength and duty cycle control to achieve accurate conversion and regulation.

FIG. 4 illustrates one embodiment of voltage regulator/converter circuitry mounted on voltage regulator/converter die 250. In this embodiment, the voltage regulator/converter is implemented with a microtransformer based DC/DC converter. The transformer performs N:1 voltage conversion. Due to process Vmax limitations, each winding includes a driver, while the control is shared.

The above-described integrated 3D voltage regulator/converter avoids the discontinuities and impedances in the VRM to die power delivery path, which give rise to amplitude/phase degradation and response time delay.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A central processing unit (CPU) comprising:
a CPU die; and
a voltage regulator/converter die bonded to the CPU die in a three dimensional assembly.

2. The CPU of claim 1 wherein the voltage regulator/converter die comprises a switching buck DC/DC converter/regulator.

3. The CPU of claim 2 wherein the voltage regulator/converter die further comprises:
one or more current drivers; and
a control unit.

4. The CPU of claim 3 wherein the voltage regulator/converter die further comprises:
a switching inductor; and
an output filter capacitor.

5. The CPU of claim 1 wherein the voltage regulator/converter die comprises a microtransformer based DC/DC converter.

6. The CPU of claim 5 wherein the microtransformer performs N:1 voltage conversions.

7. The CPU of claim 5 wherein each winding of the microtransformer includes a driver.

8. The CPU of claim 7 wherein the voltage regulator/converter die further comprises a control unit.

9. The CPU of claim 1 further comprising a package substrate bonded to the voltage regulator/converter die.

10. The CPU of claim 9 wherein the voltage regulator/converter die is pad matched to the CPU die and the package substrate.

11. The CPU of claim 1 wherein the voltage regulator/converter die is flipped and bonded to the CPU die metal side to metal side.

12. A method comprising bonding a voltage regulator/converter die to a central processing unit (CPU) die in a three-dimensional assembly.

13. The method of claim 9 further comprising bonding a package substrate to the voltage regulator/converter die.

14. The method of claim 10 wherein the voltage regulator/converter die is pad matched to the CPU die and the package substrate.

15. A system comprising:
a central processing unit (CPU) having:
a CPU die; and
a voltage regulator/converter die bonded to the CPU die in a three dimensional assembly;
a chipset coupled to the CPU; and
a main memory device coupled to the chipset.

16. The system of claim 15 wherein the voltage regulator/converter die comprises a switching buck DC/DC converter/regulator.

17. The system of claim 16 wherein the voltage regulator/converter die further comprises:
one or more current drivers; and
a control unit.

18. The system of claim 17 wherein the voltage regulator/converter die further comprises:
a switching inductor; and
an output filter capacitor.

19. The system of claim 15 wherein the voltage regulator/converter die comprises a microtransformer based DC/DC converter.

20. The system of claim 19 wherein the microtransformer performs N:1 voltage conversions.
